(19) United States
(12) Patent Application Publication
(10) Pub. No.: US 2023/0191166 A1
(43) Pub. Date: Jun. 22, 2023

(54) PERSONAL RESPIRATORY PROTECTION DEVICE

(71) Applicant: Gen5 Group, LLC, Newton, MA (US)

(72) Inventors: Andrey Sergeevich Balanev, Saint Petersburg (RU); Dmitry Mikhailovich Volobuev, Saint Petersburg (RU); Michael Gershman, Kadima-Zoran (IL); Leonid Malinin, Newton, MA (US); Alexey Yurievich Oleynikov, Saint Petersburg (RU); Pavel Anatolievich Uporov, Murino (RU)

(21) Appl. No.: 17/925,600

(22) PCT Filed: May 24, 2021
(86) PCT No.: PCT/IB2021/054493

§ 371 Date: Nov. 15, 2022

(30) Foreign Application Priority Data
May 25, 2020 (RU) RU2020117173

(51) Int. Cl. A62B 7/10; A62B 9/04; G02C 11/00

(52) U.S. Cl. CPC A62B 7/10; A62B 9/04; G02C 11/10

(57) ABSTRACT

A device is designed in the form of glasses with a frame (10) having a frontal portion (20), temporal portions (30) abutting the frontal portion on two sides, and temples (40) attached to the temporal portions. Each temporal portion (30) comprises an intake fan (31) with an air filter (50) and a discharge air duct (60), wherein nozzles (63) of the two air ducts (60) are oriented towards one another, providing the formation of substantially counter-directed streams of clean air directly under the nostrils of a user, with the result that a region of high pressure is formed, keeping non-purified ambient air from entering the nostrils.

### FIELD OF THE INVENTION

The present invention refers to the field of human respiratory system protection, in particular, to protection means with filtering elements, and can be used as personal means of protection for human respiratory organs under the conditions of dust, bacterial and other kinds of ambient air pollution.

### BACKGROUND OF THE INVENTION

Face masks of various designs and made of various materials represent the most widely used means for personal protection of human respiratory organs. In particular, such masks can cover the entire human face or only the mouth and nose and they can be made entirely of filtering materials or may have a built-in air filter that allows atmospheric air to pass through due to the rarefaction created under the mask in the course of air inhaling, or may have means for forced supply of clean air under the mask, including atmospheric air passed through the filter. A common disadvantage inherent in such personal means for human respiratory system protection consists in the impossibility or difficulty of talking because the mouth is covered by a mask and certain discomfort associated with wearing a mask, especially in public places. Most often, this disadvantage is manifested under normal conditions—for example, when a person needs to ensure personal antiviral or antiallergenic protection. In addition, the effective functioning of masks (often claimed by manufacturers) is not achieved due to a number of reasons, e.g., loose fitting of the mask to the human face; condensation of exhaled water vapors on the inner surface of the mask resulting in the formation of a nutrient medium in the mask material for the development of pathogens; reduced filtering efficiency of mask material in the case of increased volume of inhaled air caused by physical activity of mask user.

Combination of respiratory protection means with eyeglasses (in terms of design) represents one of the directions, which gained wide attention recently. In this case the face mask, as such, is eliminated, and hence the above-indicated disadvantageous features inherent in face masks are also eliminated or at least minimized.

Patent CN 202649630 U (publication date—Jan. 2, 2012) describes a personal respiratory protection device made as glasses with a frame, in which the frontal portion and temples connected to it by means of a hinged joint are hollow, wherein their cavities are interconnected by means of a duct made in the said hinge joint. A filtering material is placed in the inner space of the temples, while the temples have corresponding holes—an air-intake duct, through which external air can pass through the filtering material into the inner space of the temples and further into the inner space of the frontal portion of the frame. The device also comprises a transparent nose cap (projecting from the nose piece), which, when the device is in use, completely covers the nose of the user, while the inner space of the nose cap is connected with the internal space of the frontal portion of the frame. Such a design allows filtered air inhaled by the nose to enter the internal space of the nose cap, but at the same time creates an additional load caused by the significant aerodynamic resistance of the passageway (filled with filter) for the inhaled air.

Application US 2001/0050079 A (publication date—Dec. 13, 2001) describes a personal respiratory protection device, which is made as glasses with a frame. The frontal portion of the frame and temples are hollow; besides, the temples are made so that it is possible to connect them (by means of thin tubes) to a portable system for air cleaning and supplying cleaned air under pressure. The frame also comprises two air ducts connected with the inner space of the frontal portion of the frame and outgoing from the frame, while the free open end of each air duct is bent so that when the device is in use it is placed in the corresponding nostril. Such a design ensures the supply of clean air under pressure directly into the nostrils, but it is unaesthetic and does not prevent the partial passage of external non-cleaned air in the course of nasal respiration. To solve the latter problem, it is necessary to supply clean air at a volumetric flow rate exceeding the peak volumetric flow rate of air inhaled through the nose, which requires significant energy expenditures, increases the complexity of equipment (in particular, as described in the known device), employment of additional air-cleaning system and supplying the air under pressure to the personal respiratory protection device.

Application US 2019/0353933 A (publication date—Nov. 21, 2019) describes personal respiratory protection device, which is made as glasses with a frame, in which the frontal portion and temples are hollow. Suction fan with a filter and fan power supply source are placed in the temple. Besides, the temple also has an air intake, through which the outside air is sucked. A multitude of openings is made in the lower part of the frontal portion of the frame, through which the air that has passed through the air intake and filters outgoes from the inner space of the frontal portion of the frame. When the device is in use, this stream of clean air flows along the wings of the nose, thus creating an obstacle in the form of an air curtain that prevents non-cleaned atmospheric air from getting into the nose.

Application WO 2019/041108 A1 (publication date—Mar. 7, 2019) describes a personal respiratory protection device made in the form of glasses with a frame, in which the frontal portion is hollow. A filtering unit is connected to the frontal portion, and this unit serves to provide forced supply of filtered air into the internal cavity of the frontal portion of the frame. Besides, an air flow distributor having a multitude of openings is installed in the bottom part of the frontal portion of the frame. Clean air outgoing from the internal space of the frontal portion of the frame flows along the wings of the nose, thus creating an obstacle in the form of an air curtain, which prevents non-cleaned atmospheric air from getting into the nose. As with the device described in US 2019/0353933 A, such air curtain does not provide a sufficiently reliable barrier to the inhalation of outside air from the vicinity of the nostrils.

The personal respiratory protection device is described in patent TW M520383 U (publication date—Apr. 21, 2016). The device is made as glasses, the frame of which comprises a frontal portion made in the form of two optically transparent hollow lenses having holes in their opposite ends, nose piece connecting lenses and temples connected to lenses on the opposite ends of the nose piece. The said holes in hollow lenses are made so that the hole on the temple side connects the inner space of the lens with the inner space of the temple, while the hole on the nose piece side turns out to be located opposite the wings of the nose when the device is in use. A filter and fan that serves for suction of outside air through the air intake made in the temple wall and then through the filter are located inside the temple. The air is then supplied to the inner space of the hollow lens. When the device is in use (while worn by the user), a stream of clean air passing through the lenses and outgoing from the opposite sides towards the wings of the nose flows around the wings of the nose, thus creating an obstacle in the form of an air curtain, which prevents non-cleaned air from getting into the user's nose. Similarly, as with the devices described in applications US 2019/0353933 A and WO 2019/041108 A1, such air curtain does not provide a sufficiently reliable barrier to the inhalation of outside air from the vicinity of the nostrils.

The purpose of the present invention consists in proposing a personal respiratory protection device in the form of glasses capable to ensure forced supply of clean air to the zone of inhaled air, which provides a more reliable obstacle to inhalation of non-cleaned outside air.

### SUMMARY OF THE INVENTION

According to the present invention, the personal respiratory protection device is made in the form of glasses with a frame having a frontal portion, temporal portions abutting the frontal portion on both sides and temples attached to the temporal portions. Each temporal portion comprises an intake fan with an air filter and a discharge air duct, wherein the air duct is made in such a way that it outgoes from the temporal portion of the frame and extends at the bottom part of the frontal portion, so that nozzles of both air ducts are oriented towards one another, providing the formation of substantially counter-directed streams of air directly under the nostrils of a user, when the device is in use.

Due to the above-described arrangement of nozzles directly under the user's nostrils, two counter-directed streams of clean air are formed, which, colliding with one another, form a high pressure area that prevents the entry of non-cleaned outside air into the nostrils. As a result, the user inhales the air substantially cleaned by the filters and supplied by the fans through the air ducts.

Preferably, the fan may be represented by a double-suction fan, wherein the air intakes of the fan are located on the opposite sides of the temporal portion of the frame. This arrangement will provide a larger volume of drawn-in air and larger filter area, while the overall dimensions of the device being the same.

To provide high dust-collecting properties, the air filter can be made of electret material.

To ensure high filtration efficiency of particles having an undesirable odor, the air filter can be made of activated carbon material possessing high sorption capacity.

The air filter can be also made as a multi-layer structure, in which case at least one layer should be made of electret material or activated carbon material.

The fan is powered by a battery, which can be placed in the temporal portion of the frame and/or in the temple.

Besides, the fan power supply source can be made in the form of an autonomous portable battery with accessories enabling the wired connection to the fan.

In a particular case, a portion of the air duct extending at the bottom part of the frontal portion of the frame can be placed inside the frontal portion of the frame.

In a particular case, to provide disinfection of inhaled air, the device may be further equipped with an ultraviolet radiation source (e.g., ultraviolet light-emitting diode) installed at some point in the air stream created by the fan.

In a particular case, rotary dampers can be installed inside air ducts at nozzle outlets with the aim to adjust direction (within the prescribed limits) of counter-directed streams of air outgoing from air ducts.

In a particular case, the temples can be attached to the corresponding temporal portions of the frame by means of hinged joint.

In a particular case, the frame can be made in such a way that it is possible to install interchangeable lenses (e.g., darkened, colored, dioptric lenses), which will widen the scope of device application.

### BRIEF DESCRIPTION OF THE DRAWINGS

FIGS. 1-3 show an embodiment of a respiratory protection device according to the present invention. FIG. 1 shows a general view of the device; FIG. 2 shows a side view (without an outer side wall of the temporal portion of the frame); and FIG. 3 shows a rear view.

FIG. 4 shows the orientation relative to the user's nose of the ducts of the device presented in FIGS. 1-3, when the device is in use.

FIG. 5 shows the formation of counter-directed streams of air under the user's nostrils, when the device is in use according to the present invention.

### DETAILED DESCRIPTION OF INVENTION EMBODIMENTS

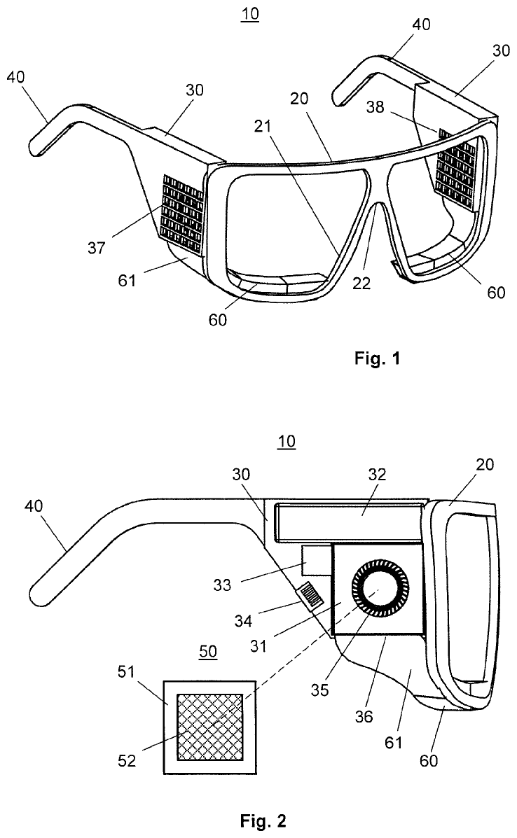

A personal respiratory protection device according to the present invention (an example of which is shown in FIGS. 1-3) is made in the form of glasses, the frame 10 of which comprises a frontal portion 20 with rims 21 for lenses and nose piece 22, as well as temporal portions 30 abutting the frontal portion 20 on both sides and temples 40 attached to temporal portions 30 by means of hinged joint.

Each temporal portion 30 is hollow and accommodates intake fan 31, rechargeable power supply source—battery 32 and controller 33 controlling the operation of fan 31 and charging process of battery 32. Connector 34 is provided for charging the battery 32 (e.g. connector of micro-USB type). A disposable current source can be also used as battery 32. All these components can be seen in FIG. 2, in which the right temporal portion 30 of frame 10 is shown without outer sidewall. Double-suction fan 31 characterized by flat configuration with double side inlets 35 and end outlet 36 is used in this embodiment. Due to its flat configuration, the fan is located in the central plane of temporal portion 30 of frame 10. For example, fan ND35B00-17J17 (manufactured by Delta Electronics, Inc.,) can be used as fan 31. It is characterized by the following technical specification: dimensions 30×30×4.5 mm, power consumption 0.5 W, capacity 0.5 l/s.

Air intakes are provided in the side walls of temporal portion 30 of frame 10 opposite inlets 35 of fan 31 (see FIG. 1): air intake 37 on the outside and air intake 38 on the inside of temporal portion 30 of frame 10. Air filter 50 (shown in FIG. 2 separately) is placed between each air intake 37 (38) and corresponding inlet 35 of fan 31. Depending on particular device design and assembling technique for the device as a whole, air filter 50 can be secured, for example, to the inner surface of the side wall of temporal portion 30, overlapping air intake 37 (38) on the inner side or to the side surface of fan 31, overlapping its inlet 35. In terms of design, air filter 50 may have, for example, a rigid frame in the form of flat frame 51, inside which filtering medium layer 52 is fixed.

Air filter 50 can be made of materials, which are commonly used for similar purposes,—namely, non-woven materials based on glass or polymer fibers (such as filtering materials of Sure Fit brand produced by Air Filters Inc.). Preferably, electret materials,—such as Technostat PLUS TS100PLUS-15 manufactured by Hollingsworth & Vose Company, possessing high dust-collecting properties and low resistance to air flow can be used as source material for filter 50. Besides, filter 50 can be made of activated carbon material,—such as Flexzorb® manufactured by Calgon Carbon Corp., possessing high sorption capacity to retain particles characterized by undesirable odor. Air filter 50 may have several layers, including layers of the said electret material or activated carbon material.

The device also comprises discharge air duct 60, inlet end 61 of which is connected to outlet 36 of fan 31. Discharge duct 60 is made as a curved conduit outgoing from temporal portion 30 of frame 10 and extending at the bottom part of frontal portion 20 of frame 10 in such a way that its distal end 62 with nozzle 63 is oriented substantially normally to the symmetry plane of frame 10 (this plane passes through nose piece 22). Discharge duct 60 outgoing from the opposite temporal portion 30 of frame 10 is made similarly.

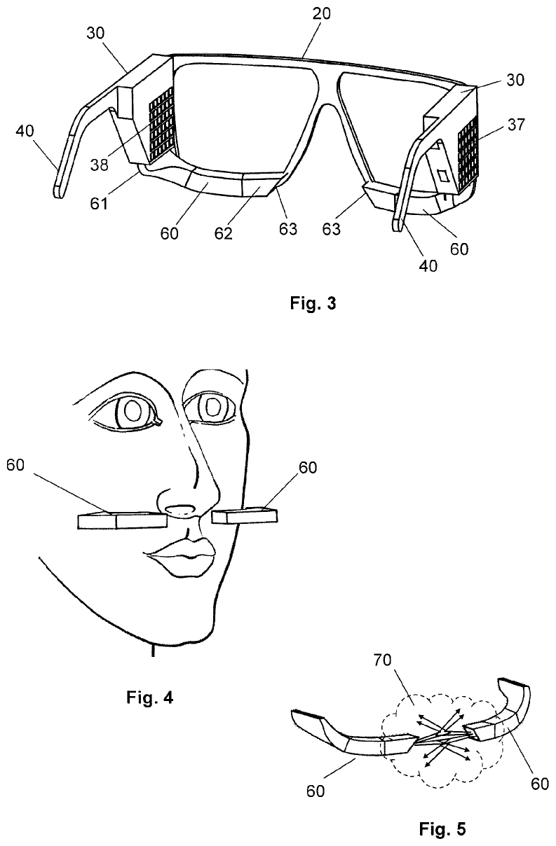

With such embodiment, nozzles 63 of both air ducts 60 (conditionally on the left and right in FIG. 3) turn out to be oriented opposite to one another, thus proving a possibility of forming (when the device is in use) substantially counter-directed streams of filtered air directly under the user's nostrils,—as shown in FIG. 4. When the said air streams collide (as indicated by arrows in FIG. 5), a high pressure area 70 is formed, which prevents non-cleaned outside air from getting into user's nostrils. As a result, the user substantially inhales the air cleaned by filters 50 and supplied by fans 31 through air ducts 60.

Additionally, rotary dampers (not shown in the Figs.) can be installed at the outlet of nozzles 63 of air ducts 60, by means of which it will be possible to adjust the direction of air stream outgoing from nozzles 63 within prescribed limits. This will allow user to direct counter-directed air streams to a desired area under user's nostrils, taking into account anatomical specific features of a particular user.

As shown in FIG. 2, a power supply source for fan 31 and controller 33 (namely, battery 32) is located in temporal part 30 of frame 20. In other embodiments of the device, the power supply source can be also located in temple 40. Besides, other embodiments of the device may comprise a portable battery carried separately from frame 10 (e.g., on user's neck, belt, chest pocket). In this case this battery will be wired to fan 31 and controller 33 via plug-in connector 34.

Other embodiments of the present invention may involve, for example, provision of air duct 60 inside frontal portion 20 of frame 10, i.e., practically, as an integral part.

Further, for the purpose of disinfection of air inhaled by the user, the device may be additionally equipped with an ultraviolet light-emitting diode installed downstream of air stream generated by fan 31, for example, directly inside air duct 60.

Besides, frontal portion 20 of frame 10 can be made so that it becomes possible to install interchangeable lenses in rims 21 (e.g., darkened, colored, or dioptric lenses), which will widen the scope of device application.

1. A personal respiratory system protection device made in the form of glasses with a frame having a frontal portion, temporal portions abutting the frontal portion on both sides and temples attached to the temporal portions, wherein each temporal portion comprises an intake fan with an air filter and a discharge air duct, wherein the air duct is made in such a way that it outgoes from the temporal portion of the frame and extends at the bottom of the frontal portion, so that nozzles of both air ducts are oriented towards one another, providing the formation of substantially counter-directed streams of air directly under the nostrils of a user, when the device is in use.

2. The device of claim 1, wherein a double-suction fan serves as the fan, wherein air intakes of the fan are located on the opposite lateral sides of the temporal portion of the frame.

3. The device of claim 1, wherein the air filter is made of electret material.

4. The device of claim 1, wherein the air filter is made of activated carbon material.

5. The device of claim 1, wherein the air filter is made as a multilayer structure, wherein at least one layer of the said multi-layer structure is made of electret material or activated carbon material.

6. The device of claim 1, wherein a battery placed in the temporal portion of the frame serves as a power supply source for the fan.

7. The device of claim 1, wherein a battery placed in the temple serves as a power supply source for the fan.

8. The device of claim 1, wherein an autonomous portable battery provided with wire-based connection to the fan serves as a power supply source for the fan.

9. The device of claim 1, wherein the air duct portion extending at the bottom part of the frontal portion of the frame is located inside the frontal portion of the frame.

10. The device of claim 1, further comprising an ultraviolet light-emitting diode installed downstream of the air stream produced by the fan.

11. The device of claim 1, wherein rotary dampers are installed inside the air ducts at the nozzle outlets with the aim to adjust the direction of the said counter-directed streams of air.

12. The device of claim 1, wherein the temples are attached to the corresponding temporal portion of the frame by means of hinged joints.

13. The device of claim 1, wherein the frame is made so that it is possible to install interchangeable lenses in the frame.
